(19) United States
(12) Patent Application Publication
(10) Pub. No.: US 2005/0078058 A1
(43) Pub. Date: Apr. 14, 2005

(54) Method and apparatus for driving plasma display panel

(76) Inventor: Jae Hyun Loh, Dalseo-ku (KR)

Correspondence Address: FLESHNER & KIM, LLP, P.O. BOX 221200, CHANTILLY, VA, 20153, US

(21) Appl. No.: 10/926,340

(22) Filed: Aug. 26, 2004

(30) Foreign Application Priority Data
Aug. 27, 2003 (KR) P2003-59505

(51) Int. Cl. G09G 3/28

(52) U.S. Cl. 345/60

(57) ABSTRACT

A method and apparatus for driving a plasma display panel for preventing a generation of over current in the panel are disclosed. In the method, a scanning pulse falling from a first voltage is sequentially applied to a plurality of scan electrodes, and a data pulse is simultaneously applied to a plurality of address electrodes to select a cell. Said first voltage on the scan electrodes is lowered into a second voltage after said scanning pulse was applied to the scan electrodes in the last line. A time when said first voltage is lowered into said second voltage is controlled differently at any at least one of the scan electrodes.

This application claims the benefit of Korean Patent Application No. P2003-59505 filed in Korea on Aug. 27, 2003, which is hereby incorporated by reference.

### BACKGROUND OF THE INVENTION

1. Field of the Invention

This invention relates to a plasma display panel, and more particularly to a method and apparatus for driving a plasma display panel that is adaptive for preventing a generation of over current in the panel.

2. Description of the Related Art

Generally, a plasma display panel (PDP) excites and radiates a phosphorus material using an ultraviolet ray generated upon discharge of an inactive mixture gas such as He+Xe, Ne+Xe or He+Ne+Xe, to thereby display a picture. Such a PDP is easy to be made into a thin-film and large-dimension type. Moreover, the PIMP provides a very improved picture quality owing to a recent technical development.

Referring to FIG. 1, a discharge cell of a conventional three-electrode, AC surface-discharge PDP includes a scan electrode 30Y and a sustain electrode 30Z provided on an upper substrate 10, and an address electrode 20X provided on a lower substrate 13.

Each of the scan electrode 30Y and the sustain electrode 30Z includes transparent electrodes 32Y and 12Z, and metal bus electrodes 13Y and 13Z having smaller line widths than the transparent electrodes 12Y and 12Z and provided at one edge of the transparent electrodes 12Y and 12Z. The transparent electrodes 12Y and 12Z are usually formed from indium-tin-oxide (ITO) on the upper substrate 10. The metal bus electrodes 13Y and 13Z are usually formed from a metal such as chrome (Cr), etc. on the transparent electrodes 12Y and 12Z to thereby reduce a voltage drop caused by the transparent electrodes 12Y and 12Z having a high resistance.

On the upper substrate 10 provided, in parallel, with the scan electrode 30Y and the common sustain electrode 30Z, an upper dielectric layer 14 and a protective film 16 are disposed. Wall charges generated upon plasma discharge are accumulated onto the upper dielectric layer 14. The protective film 16 prevents a damage of the upper dielectric layer 14 caused by a sputtering during the plasma discharge and improves the emission efficiency of secondary electrons. This protective film 16 is usually made from magnesium oxide (MgO).

A lower dielectric layer 22 and barrier ribs 24 are formed on the lower substrate 18 provided with the address electrode 20X. The surfaces of the lower dielectric layer 22 and the barrier ribs 24 are coated with a phosphorous material 26. The address electrode 20X is formed in a direction crossing the scan electrode 30Y and the sustain electrode 30Z. The barrier rib 24 is formed in parallel to the address electrode FOX to thereby prevent an ultraviolet ray and a visible light generated by a discharge from being leaked to the adjacent discharge cells. The phosphorous material 26 is excited by an ultraviolet ray generated during the plasma discharge to generate any one of red, green and blue visible light rays. An inactive mixture gas for a gas discharge is injected into a discharge space defined between the upper and lower substrate 10 and 18 and the barrier rib 24.

Such a PDP makes a time-divisional driving of one frame, which is divided into various sub-fields having a different emission frequency, so as to realize gray levels of a picture. Each sub-field is again divided into an initialization period for initializing the entire field, an address period for selecting a scan line and selecting the cell from the selected scan line and a sustain period for expressing gray levels depending on the discharge frequency. Herein, the initialization period is again divided into a set-up interval supplied with a rising ramp waveform and a set-down interval supplied with a falling ramp waveform.

For instance, when it is intended to display a picture of 256 gray levels, a frame interval equal to 1/60 second (i.e. 16.67 msec) is divided into 8 sub-fields SF1 to SF8 as shown in FIG. 2. Each of the 8 sub-field SF1 to SF8 is divided into an initialization period, an address period and a sustain period as mentioned above. Herein, the initialization period and the address period of each sub-field are equal for each sub-field, whereas the sustain period and the number of sustain pulses assigned thereto are increased at a ratio of 2ⁿ (wherein n=0, 1, 2, 3, 4, 5, 6 and 7) at each sub-field.

FIG. 3 shows a driving waveform of the PDP applied to two sub-fields.

In FIG. 3, Y represents the scan electrode; Z does the sustain electrode; and X does the address electrode.

Referring to FIG. 3, the PDP is divided into an initialization period for initializing, the full fields, an address period for selecting a cell, and a sustain period for sustaining a discharge of the selected cell for its driving.

In the initialization period, a rising ramp waveform Ramp-up is simultaneously applied to all the scan electrodes Y1 to Yn in a set-up interval. This rising ramp waveform ramp-up causes a weak discharge within cells at the full field to generate wall charges within the cells. In the set-down internal, aster the rising ramp waveform Ramp-up was supplied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a scanning pulse scan having a negative scan voltage −Vy is sequentially applied to the scan electrodes Y1 to Yn and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge. In the remaining period other than a period when the scanning pulse scan with a negative scan voltage −Vy supplied for an address discharge is applied, a positive scan bias voltage Vscb is applied until a time T0 when the address period is terminated.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y1 to Yn and the sustain electrodes Z. Then, a wall voltage within the cell selected by the address discharge is added to the sustain pulse sus to thereby generate a sustain discharge taking a surface-discharge type between the scan electrodes Y1 to Yn and the sustain electrode Z whenever each sustain pulse sus is applied. Finally, after the sustain discharge was finished, an erasing ramp waveform erase having a small pulse width is applied to the sustain electrode Z to thereby erase wall charges left within the cells.

Meanwhile, if a negative scanning pulse scan is sequentially applied to, the scan electrodes Y1 to Yn and, at the same time, a positive data pulse data is applied to the address electrodes X in the address period, then currents in to in flows from the address electrodes X into the scan electrodes Y1 to Yn as shown in FIG. 4. This is because potentials of the address electrodes X are higher than those of the scan electrodes Y1 to Yn.

However, since positive scan bias voltages Vscb supplied to the scan electrodes Y1 to Yn drop into a ground potential simultaneously at such a termination time of the address period, there is raised a problem in that a data driver is overheated or damaged due to an over current.

More specifically, as shown in FIG. 5, the first scan electrode Y1 maintains a positive scan bias voltage Vscb and then drops into a ground potential at a termination time T0 of the address period. At this time, the address electrodes X1 to Xm remain at a ground potential. A displacement current of the first scan electrode Y1 generates a discharge between the first scan electrode Y1 and the address electrodes X1 to Xm. Thus, a reverse current flows from the first scan electrode Y1 into the address electrodes X1 to Xm. Furthermore, the second scan electrode Y2 also maintains a positive scan bias voltage Vscb and then drops into a ground potential at a termination time T0 of the address period. A displacement current of the second scan electrode Y2 generates a discharge between the second scan electrode Y2 and the address electrodes X1 to Xm. Thus, a reverse current flow from the second scan electrode, Y2 into the address electrodes X1 to Xm. Likewise, the nth scan electrode Yn also maintains a positive scan bias voltage Vscb and then drops into a ground potential at a termination time T0 of the address period. A displacement current of the nth scan electrode Yn generates a discharge between the nth scan electrode Yn and the address electrodes X1 to Xm. Thus, a reverse current flow from the nth scan electrode Yn into the address electrodes X1 to Xm. Accordingly, since the scan electrodes Y1 to En simultaneously drop into a ground potential at a termination time T0 of the address period to generate a displacement current, a reverse current simultaneously flow from all the scan electrodes Y1 to Yn into the address electrodes Y1 to Yn as shown in FIG. 6. As such a reverse current is simultaneously applied to the data driver, the data driver may be overheated or damaged due to an over current.

### SUMMARY OF THE INVENTION

Accordingly, it is an object of the present invention to provide a method and apparatus for driving a plasma display panel that is adaptive for preventing a generation of over current in the panel.

In order to achieve these and other objects of the invention, a method of driving a plasma display panel according to one aspect of the present invention includes the steps of sequentially applying a scanning pulse falling from a first voltage to a plurality of scan electrodes and simultaneously applying a data pulse to a plurality of address electrodes to thereby select a cell; lowering said first voltage on the scan electrodes into a second voltage after applying said scanning pulse to the scan electrodes in the last line; and differently controlling a time when said first voltage is lowered into said second voltage from any at least one of the scan electrodes.

In the method, said time when said first voltage is lowered into said second voltage is controlled in such a manner to be lowered differently at each scan electrode.

Herein, said time when said first voltage is lowered into said second voltage is controlled in such a manner to be sequentially lowered at each scan electrode.

Alternatively, said time when said first voltage is lowered into said second voltage is controlled in such a manner to be lowered differently for each j scan electrodes (wherein j as an integer).

Herein, said time when said first voltage is lowered into said second voltage is controlled in such a manner to be sequentially lowered for each j scan electrodes (wherein j is an integer).

A driving apparatus for a plasma display panel according to another aspect of the present invention includes a scan driver for sequentially applying a scanning pulse falling from a first voltage to a plurality of scan electrodes and applying said scanning pulse to the scan electrodes in the last line, and thereafter for lowering said first voltage on the scan electrodes into a second voltage, a data driver for simultaneously applying a data pulse to a plurality of address electrodes to select a cell; and a controller for differently controlling a time when said first voltage is lowered into said second voltage from any at least one of the scan electrodes.

In the driving apparatus, said time when said first voltage is lowered into said second voltage is controlled in such a manner to be lowered differently at each scan electrode.

Herein, said time when said first voltage is lowered into said second voltage is controlled in such a manner to be sequentially lowered at each scan electrode.

Alternatively, said time when said first voltage is lowered into said second voltage is controlled in such a manner to be lowered differently for each j scan electrodes (wherein j is an integer).

Herein, said time when said first voltage is lowered into said second voltage is controlled in such a manner to be sequentially lowered for each j scan electrodes (wherein j is an integer).

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a discharge cell structure of a conventional three-electrode, AC surface-discharge plasma display panel;

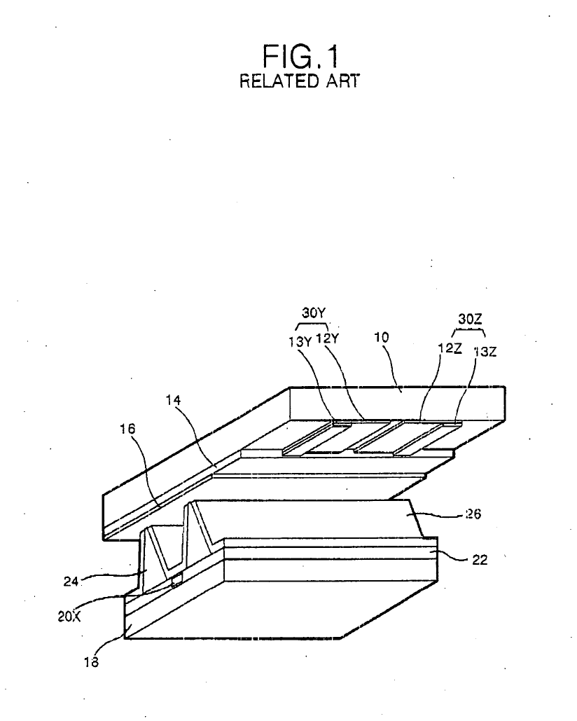

FIG. 2 illustrates sub-fields included in one frame of the conventional plasma display panel;

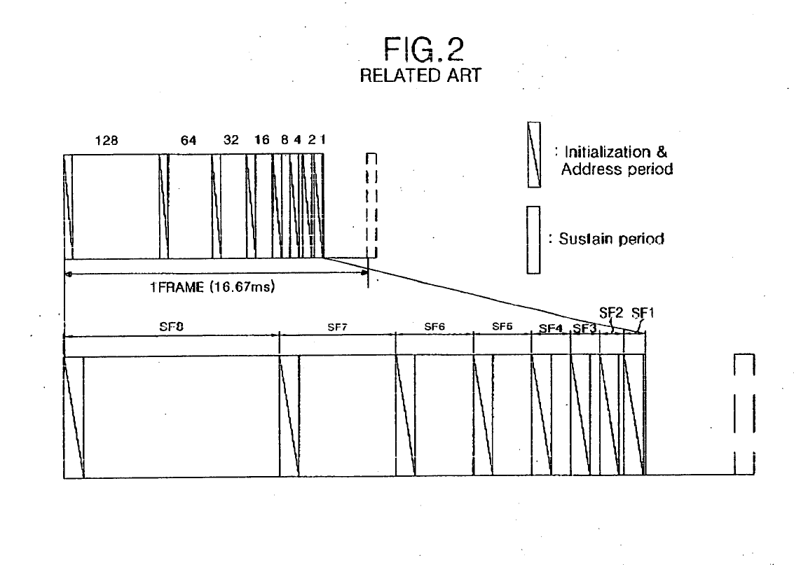

FIG. 3 is a waveform diagram of driving signals supplied to the electrodes during the sub-fields shown in FIG. 2;

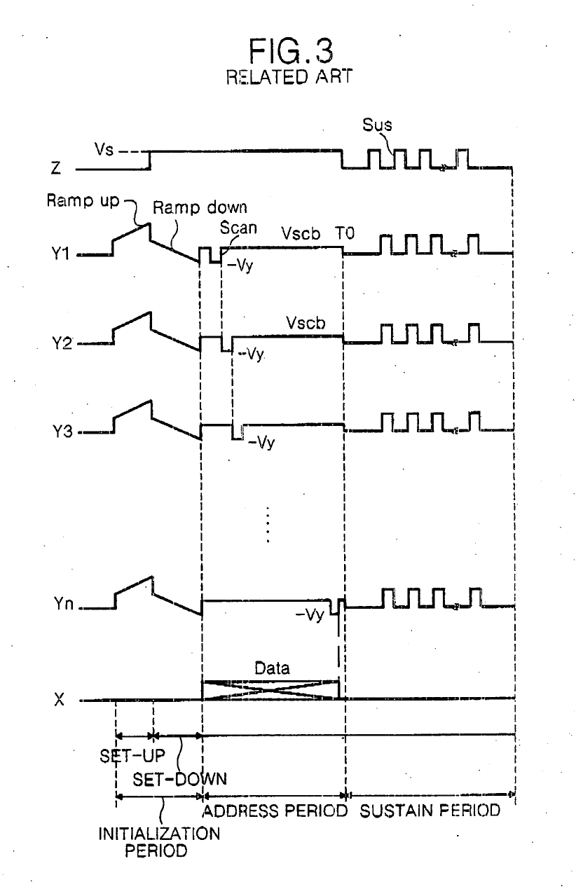

FIG. 4 depicts a flow of current formed on the panel by the driving signals of the plasma display panel shown in FIG. 3;

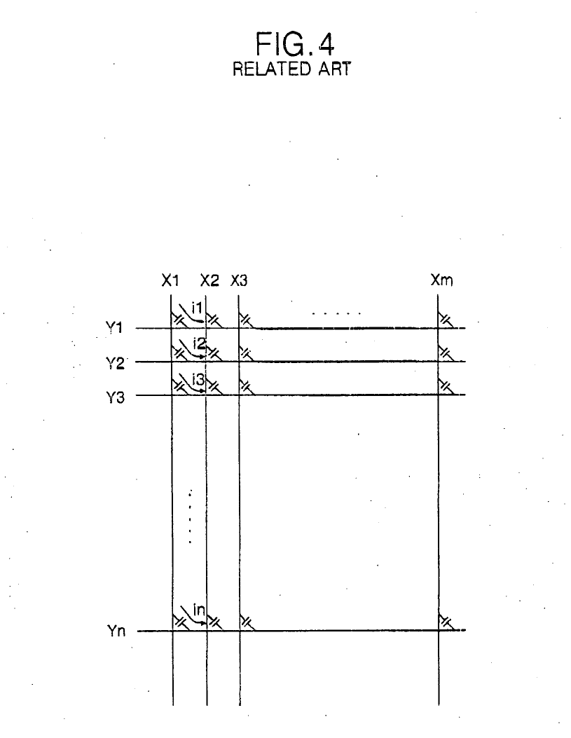

FIG. 5 depicts a current flow at a T0 time of the plasma display panel shown in FIG. 3;

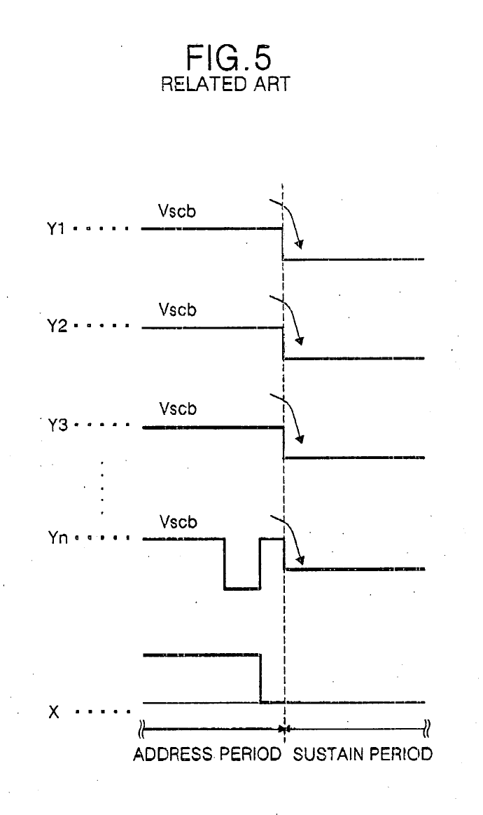

FIG. 6 depicts a flow of reverse current formed on the panel at a T0 time of the plasma display panel shown in FIG. 3;

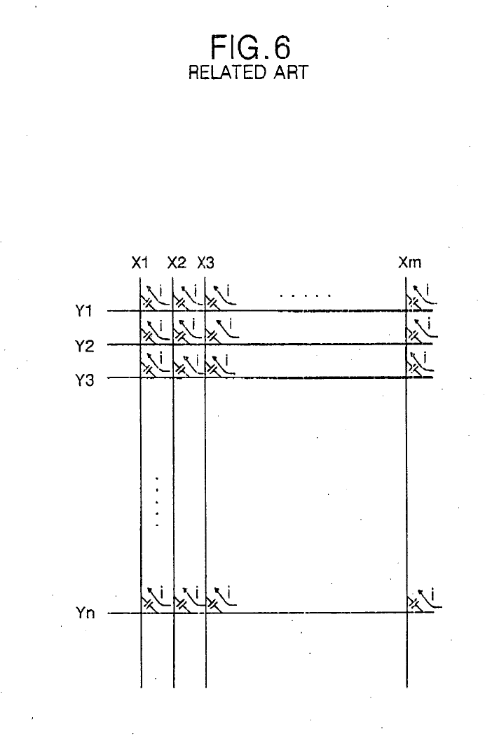

FIG. 7 is a waveform diagram of driving signals for a plasma display panel according to a first embodiment of the present invention;

FIG. 8 depicts a flow of current formed on the panel by the driving signals of the plasma display panel shown in FIG. 7;

FIG. 9 is a block diagram showing a configuration of a driving apparatus of the plasma display panel for generating the driving signals of the plasma display panel shown in FIG. 7;

FIG. 10 is a detailed block circuit diagram of the driving apparatus for the plasma display panel shown in FIG. 9;

FIG. 11 is a circuit diagram of the scan driver in the driving apparatus for the plasma display panel shown in FIG. 9;

FIG. 12 is a waveform diagram of driving signals for a plasma display panel according to a second embodiment of the present invention;

FIG. 13 depicts a flow of current formed on the panel by the driving signals o-r the plasma display panel shown in FIG. 11;

FIG. 14 is a block diagram showing a configuration of a driving apparatus of the plasma display panel for generating the driving signals of the plasma display panel shown in FIG. 12.

### DETAILED DESCRIPTION OF THE PREFERRED EMBODIMENT

Reference will now be made in detail to the preferred embodiments of the present invention, examples of which are illustrated in the accompanying drawings.

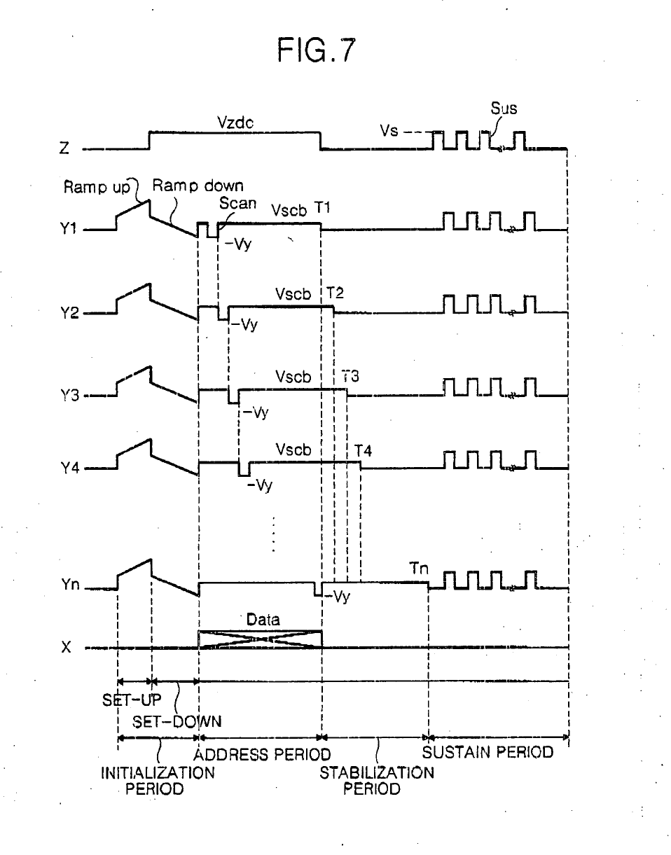

Hereinafter, the preferred embodiments of the present invention will be described in detail with reference to FIGS. 7 to 14.

FIG. 7 is a waveform diagram for explaining a method of driving a plasma display panel according to a first embodiment of the present invention.

In FIG. 7, Y represents the scan electrode; Z does the sustain electrode; and X does the address electrode.

Referring to FIG. 7, the PDP according to the first embodiment of the present invention is divided into an initialization period for initializing the full field, an address period for selecting a cell, an stabilization period for stably driving the PDP and a sustain period for sustaining a discharge of the selected cell for its driving.

In the initialization period, a rising ramp waveform Ramp-up is simultaneously applied to all the scan electrodes Y1 to Yn in a set-up interval. This rising ramp waveform Ramp-up causes a weak discharge within cells at the full field to generate wall charges within the cells. In the set-down interval, after the rising ramp waveform Ramp-up was supplied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a scanning pulse scan having a negative scan voltage −Vy is sequentially applied to the scan electrodes Y1 to Yn and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge. A positive scan bias voltage Vscb is applied in the remaining period other than a period when the scanning pulse scan with a negative scan voltage −Vy supplied for an address discharge is applied.

Meanwhile, a positive direct current voltage Vzdc having a sustain voltage level Vs is applied to the sustain electrodes Z during the set-down internal and the address period.

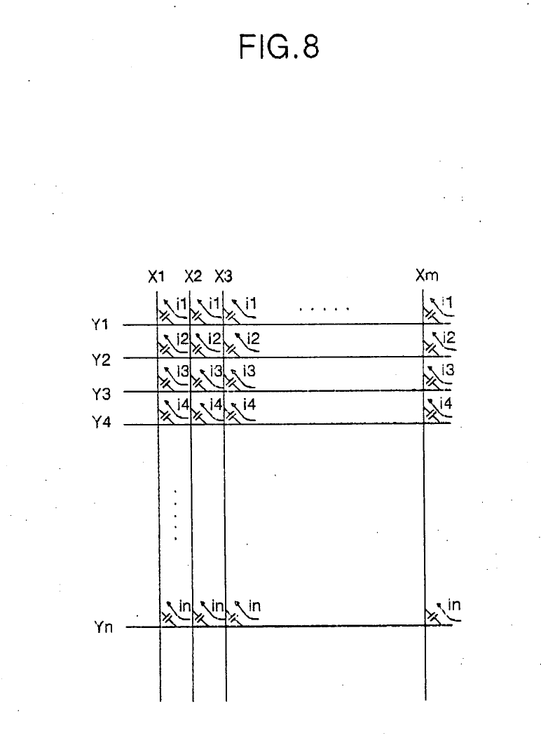

In the stabilization period, positive scan bias voltages Vscb supplied to the scan electrodes Y1 to Yn during the address period sequentially drop onto a ground potential. More specifically, the firs; scan electrode Y1 drops into a ground potential at a T1 time. Thus, at the T1 time, a first reverse current i1 flows from the first scan electrode Y1 into the address electrodes X1 to Xm as shown in FIG. 8. Further, the second scan electrode Y2 drops into a around potential at a T2 time. Thus, at the T2 time, a second reverse current i2 flows from the second scan electrode Y2 into the address electrodes X1 to Xm as shown in FIG. 8. Likewise, the nth scan electrode Yn drops into a ground potential at a Tn time. Thus, at the Tn time, a nth reverse current in flows from the second scan electrode Yn into the address electrodes X1 to Xm. Such first to nth reverse currents i1 to in is fed from the scan electrodes Y1 to Yn into the address electrodes X1 to Xm at a different time, so that it can prevent an over current from being applied to the data driver. Accordingly, it becomes possible to prevent a damage of the data driver as well as an overheating of the panel caused by an over current.

In the sustain period, a sustaining pulse sus is alternately applied to the scan electrodes Y1 to Yn and the sustain electrodes Z. Then, a wall voltage within the cell selected by the address discharge is added to the sustain pulse sus to thereby generate a sustain discharge taking a surface-discharge type between the scan electrodes Y1 to Yn and the sustain electrode Z whenever each sustain pulse sus is applied. Finally, after the sustain discharge was finished, an erasing ramp waveform erase having a small pulse width is applied to the sustain electrode Z to thereby erase wall charges left within the cells.

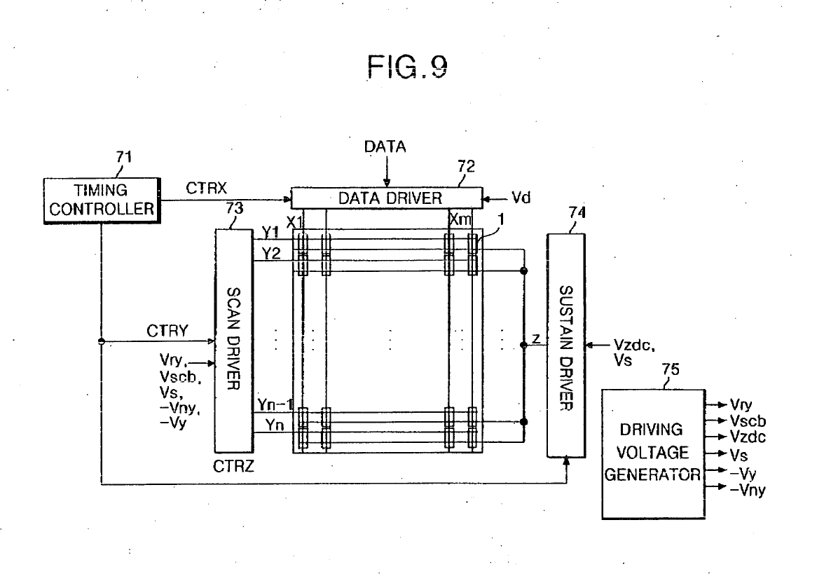

FIG. 9 shows a PDP driving apparatus for generating driving signals for the plasma display panel shown in FIG. 7.

Referring to FIG. 9, the PDP driving apparatus includes a data driver 72 for supplying a data to the address electrodes X1 to Xm of the PDP, a can driver 73 for driving the scan electrodes Y1 to Yn, a sustain driver 74 for driving the sustain electrodes Z that is common electrodes, a timing controller 71 for controlling each driver 72, 73 and 74, and a driving voltage generator 75 for supplying a driving voltage required for each driver 72, 73 and 74.

The data driver 72 is supplied with a data that is subject to an inverse-gamma correction and an error diffusion by an inverse-gamma correction circuit and an error diffusion circuit (not shown) and thereafter mapped onto each sub-field by a sub-field mapping circuit. The data driver 72 samples and latches a data in response to a timing control signal CTRX from the timing controller 71, and then supplies the data to the address electrodes X1 to Xm.

The scan driver 73 applies a rising ramp waveform Ramp-up to the scan electrodes Y1 to Yn during the set-up interval of the initialization period and then applies a falling ramp waveform Ramp-down during the set-down interval thereof under control of the timing controller 71. Further, the scan driver 73 sequentially supplies a scanning pulse to the scan electrodes Y1 to Yn during the address period and then applies a sustaining pulse sus during the sustain period under control of the timing controller 71.

The sustain driver 74 constantly supplies a positive direct current (DC) voltage Vzdc to the sustain electrodes Z during the address period, and then is operated alternately with the scan driver 73 to apply a sustaining pulse sus to the sustain electrodes Z during the sustain period under control of the timing controller.

The timing controller 71 receives vertical/horizontal synchronizing signals and a clock signal to generate timing control signals CTRX, CTRY and CTRZ required for each driver and applies the timing control signals CTRX, CTRY and CTRZ to the corresponding drivers 72, 73 and 74, thereby controlling each driver 72, 73 and 74. The data control signal CTRX includes a sampling clock for sampling a data, a latch control signal and a switching control signal for controlling an ON/OFF time of an energy recovery circuit and a driving switching device. The scan control signal CTRY includes a switching control signal for controlling an ON/OFF time of the energy recovery circuit and the driving switching device within the scan driver 73. The sustain control signal CTRZ includes a switching control signal for controlling an ON/OFF time of the energy recovery circuit and the driving switching device within the sustain driver 74. Particularly, the scan control signal CTRY acts as first to seventh control signals Cq1 to Cq7 for driving switches of the driving circuit included in the scan driver 73.

The driving voltage generator 75 generates a voltage Vry of the rising ramp waveform Ramp-up, a voltage −Vny of the falling ramp waveform Ramp-down, al DC voltage Vzdc applied to the sustain electrodes Z during the address period, a scan bias voltage Vscb, a scan voltage −Vy, a sustain voltage Vs and a data voltage, etc. Such driving voltages may be changed depending upon a component of discharge gas or a structure of discharge cell.

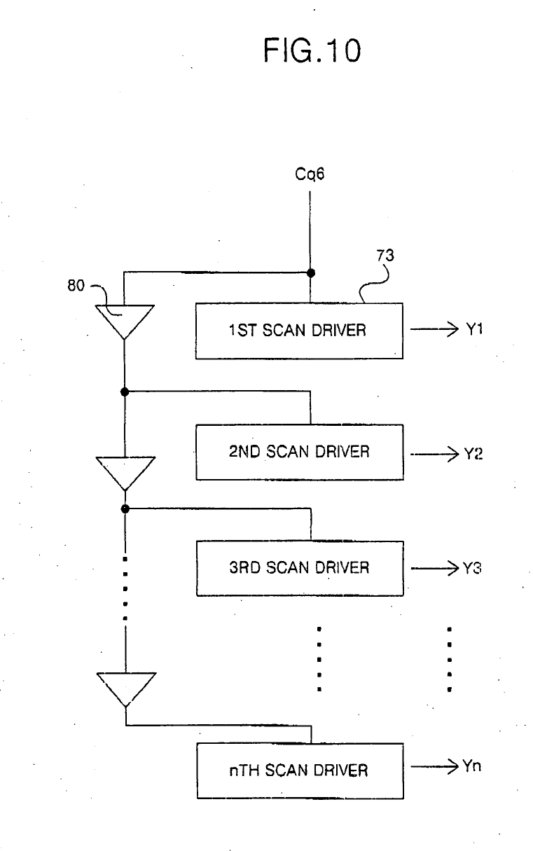

FIG. 10 is a detailed block circuit diagram of the driving apparatus for the plasma display panel shown in FIG. 9.

Referring to FIG. 10, the driving apparatus includes a scan driver 73, and a delay 80 connected to each scan driver 73.

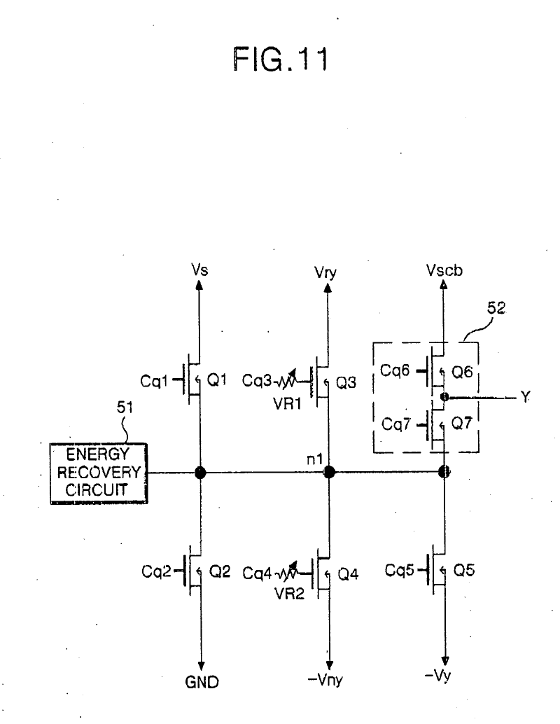

As shown in FIG. 11, the scan driver 73 includes an energy recovery circuit 51, first to fifth switching devices Q1 to Q5 and a driving switch circuit 52.

The energy recovery circuit 51 recovers energy of a reactive power that does not contribute to a discharge in the PDP from the scan electrodes Y1 to Yn, and charges the scan electrodes Y1 to Yn using the recovered energy. The energy recovery circuit 51 can be implemented by any well-known energy recovering circuit.

The first switching device Q1 is connected between a sustain voltage source Vs and a first node n1 to apply a sustain voltage Vs to the first node n1 under control of a timing controller (not shown).

The second switching device Q2 is connected between a ground voltage source GND and the first node n1 to apply a ground voltage GND to the first node n1 under control of the timing controller.

The third switching device Q3 is connected between a rising ramp voltage source Vry and the first node to apply a rising ramp waveform Ramp-up to the first node n1 at a slope determined by a predetermined RC time constant under control of the timing controller. A variable resistor VR1 and a capacitor (not shown) for adjusting a slope of the rising ramp waveform Ramp-up are connected to a control terminal of the third switching device Q3.

The fourth switching device Q4 is connected between a falling ramp voltage source −Vny and the first node to apply a falling ramp waveform Ramp-down to the first node n1 at a slope determined by a predetermined R-time constant under control of the timing controller. A variable resistor VR1 and a capacitor (not shown) for adjusting a slope of the falling ramp waveform Ramp-down; are connected to a control terminal of the fourth switching device Q4.

The fifth switching device Q5 is connected between a scan voltage source −Vy and the first node n1 to apply a negative scan voltage −Vy to the first node n1 under control of the timing controller.

The driving switch circuit 52 includes sixth and seventh switching devices Q6 and Q7 connected, in a push-pull type, between a scan bias voltage source Vscb and the first node n1. An output terminal between the sixth and seventh switching devices Q6 and Q7 is connected to the scan electrodes Y1 to Yn. Each of the sixth and seventh switching devices Q6 and Q7 applies a scan bias voltage Vscb or a voltage at the first node n1 to the scan electrodes Y1 to Yn under control of the timing controller.

The delay 80 plays a role to delays a control signal Cq6 inputted to a control terminal (or gate terminal) of the sixth switch Q6 such that a positive scan bias voltage Vscb supplied during the address period sequentially drops into a ground potential. Such a delay 80 can employ an RC de-ay to easily delay signals.

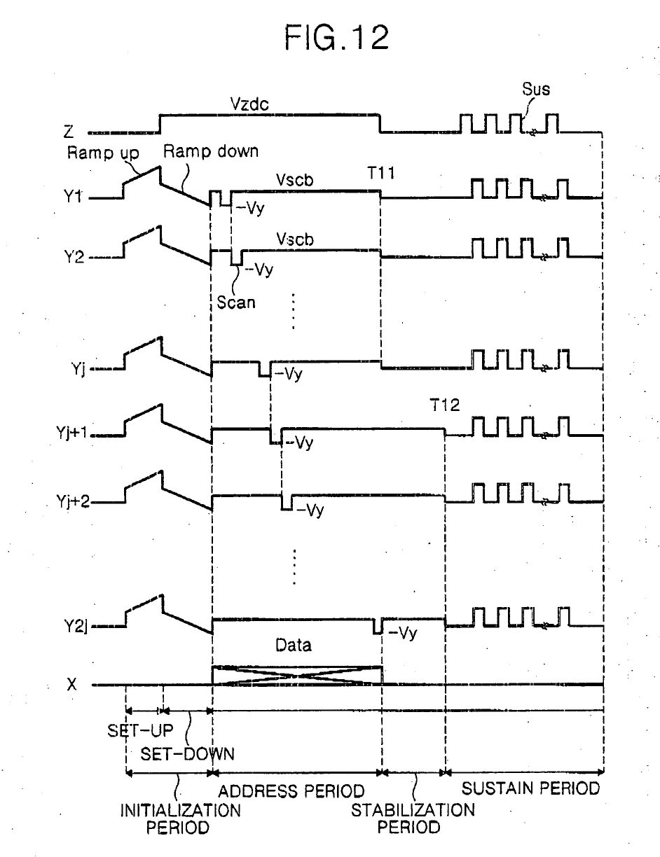

In the mean time, in a driving waveform of the PDP according to the first embodiment of the present invention, positive scan bias voltages Vscb sequentially drops into a ground potential such that the stabilization period becomes too long, thereby shortening the sustain period. Accordingly, there is suggested a driving waveform as shown in FIG. 12.

FIG. 12 is a waveform diagram for explaining a method of driving a plasma display panel according to a second embodiment of the present invention.

In FIG. 12, Y represents the scan electrode; Z does the sustain electrode; and X does the address electrode.

Referring to FIG. 12, the PDP according to the second embodiment of the present invention is divided into an initialization period for initializing the full field, an address period for selecting a cell, an stabilization period for stably driving the PDP and a sustain period for sustaining a discharge of the selected cell for its driving.

In the initialization period, a rising ramp waveform Ramp-up is simultaneously applied to all the scan electrodes Y1 to Yn in a set-up interval. This rising ramp waveform Ramp-up causes a weak discharge within cells at the full field to generate wall charges within the cells. In the set-down interval, after the rising ramp waveform Ramp-up was supplied, a falling ramp waveform Ramp-down failing from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge Within the cells of the full field.

In the address period, a scanning pulse scan having a negative scan voltage −Vy is sequentially applied to the scan electrodes Y1 to Yn and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge. A positive scan bias voltage Vscb is applied in the remaining period other than a period when the scanning pulse scan with a negative scan voltage Vy supplied for an address discharge is applied.

Meanwhile, a positive direct current voltage Vzdc having a sustain voltage level Vs is applied to the sustain electrodes 2 during the set-down interval and the address period.

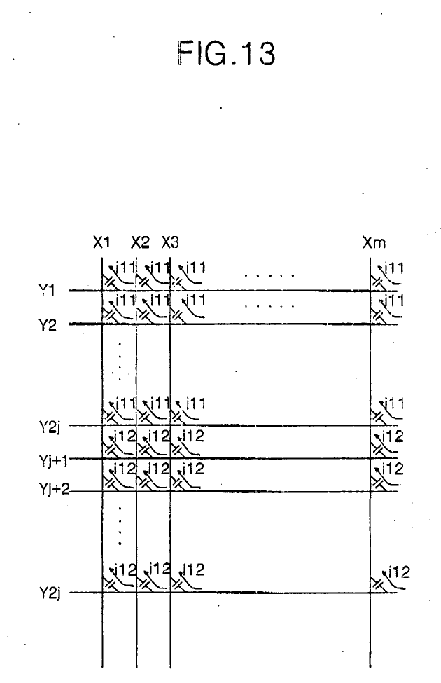

In the stabilization period, positive scan bias voltages Vscb supplied to the scan electrodes Y1 to Yn during the address period sequentially drop into a ground potential for each j lines (wherein j is an integer). More specifically, the 1st to jth scan electrodes Y1 to Yj drops into a ground potential at a T11 time. Thus, at the T11 time, a 11th Reverse current i11 flows from tine 1st to jth scan electrodes Y1 to Yj into the address electrodes X1 to Xm as shown in FIG. 13. Herein, the scan electrodes Y drop into a ground potential simultaneously for j lines by j lines within a range in which the 11th reverse current ill does not make a damage of the data driver. Further, the (j+1)th to (2j)th scan electrodes Yj+1 to Y2j drops into a ground potential at a T12 time. Thus, at the T12 time, a 12th reverse current i12 flows from the (j+1)th to (2j)th scan electrodes Y+1 to Y2j into the address electrodes X1 to Xm as shown in FIG. 12. The scan electrodes Y sequentially drop into a ground potential in this manner, so that it becomes possible to assure a sufficient sustain period as well as to prevent a damage of the driver caused by an over current. Also, it becomes possible to prevent an overheating of the panel.

In the sustain period, a sustaining pulse sus is alternately applied to the scan electrodes Y1 to Yn and the sustain electrodes Z. Then, a wall voltage within the cell selected by the address discharge is added to the sustain pulse sus to thereby generate a sustain discharge taking a surface-discharge type between the scan electrodes Y1 to Yn and the sustain electrode Z whenever each sustain pulse sus is applied. Finally, after the sustain discharge was finished an erasing ramp waveform erase having a small pulse width is applied to the sustain electrode Z to thereby erase wall charges left within the cells.

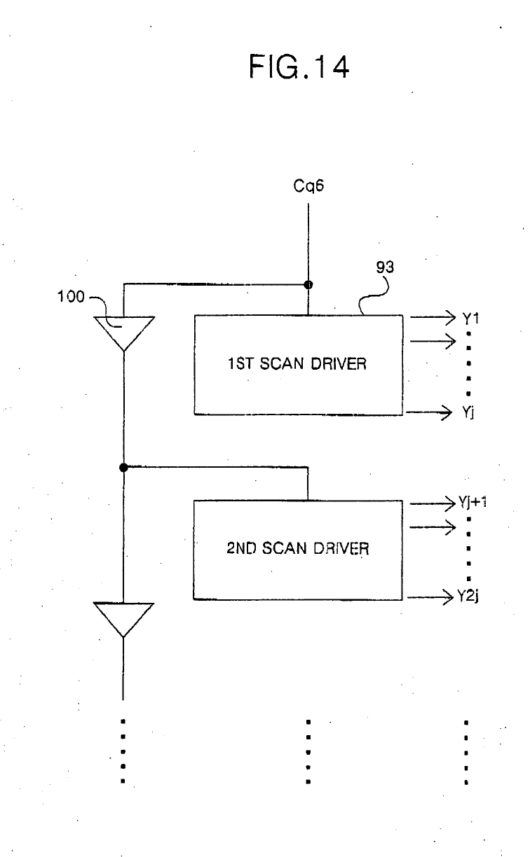

FIG. 14 is a block circuit diagram of a driving apparatus for generating driving signals for the plasma display panel shown in FIG. 12.

Referring to FIG. 12, the driving apparatus includes a scan driver 93, and a delay 100 connected to each scan driver 93.

Since the scan driver 93 is identical to the scan driver 73 shown in FIG. 11, an explanation as to it will be omitted.

The delay 100 plays a role to delay a control signal Cq6 inputted to a control terminal (or gate terminal) of the sixth switch Q6 such that positive scan bias voltages Vscb supplied during the address period sequentially drop into a ground potential j lines by j lines. Such a delay 100 can employ an RC delay to easily delay signals.

As a result, the second embodiment of than present invention can assure the sustain period more sufficiently than the first embodiment of the present invention.

As described above, according to the present invention, positive scan bias voltages supplied to the scan electrodes during the address period drop into a ground potential at a different time to thereby reduce reverse currents flowing from the scan electrodes into the address electrodes, so that it becomes possible to prevent a damage of the data driver as well as an overheating of the panel caused by an over cur-ent.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention Accordingly, the scope of the invention shall be determined only by the appended claims and their equivalents.

1. A method of driving a plasma display panel, comprising the steps of:
sequentially applying a scanning pulse falling from a first voltage to a plurality of scan electrodes and simultaneously applying a data pulse to a plurality of address electrodes to thereby select a cell;
lowering said first voltage on the scan electrodes into a second voltage after applying said scanning pulse to the scan electrodes in the last line; and
differently controlling a time when said first voltage is lowered into said second voltage from any at least one of the scan electrodes.

2. The method as claimed in claim 1, wherein said time when said first voltage is lowered into said second voltage is controlled in such a manner to be lowered differently at each scan electrode.

3. The method as claimed in claim 2, wherein said time when said first voltage is lowered into said second voltage is controlled in such a manner to be sequentially lowered at each scan electrode.

4. The method as claimed in claim 1, wherein said time when said first voltage is lowered into said second voltage is controlled in such a manner to be lowered differently for each j scan electrodes (wherein j is an integer).

5. The method as claimed in claim 4, wherein said time when said first voltage is lowered into said second voltage is controlled in such a manner to be sequentially lowered for each j scan electrodes (wherein D is an integer).

6. A driving apparatus for a plasma display panel, comprising:
a scan driver for sequentially applying a scanning pulse falling from a first voltage to a plurality of scan electrodes and applying said scanning pulse to the scan electrodes in the last liner and thereafter for lowering said first voltage on the scan electrodes into a second voltage;
a data driver for simultaneously applying a data pulse to a plurality of address electrodes to select a cell; and
a controller for differently controlling a time when said first voltage is lowered into said second voltage from any at least one of the scan electrodes.

7. The driving apparatus as claimed in claim 6, wherein said time when said first voltage is lowered into said second voltage is controlled in such a manner to be lowered differently at each scan electrode.

8. The driving apparatus as claimed in claim 7, wherein said time when said first voltage is lowered into said second voltage is controlled in such a manner to be sequentially lowered at each scan electrode.

9. The driving apparatus as claimed in claim 6, wherein said time when said first voltage is lowered into said second voltage is controlled in such a manner to be lowered differently for each j scan electrodes (wherein j is an integer).

10. The driving apparatus as claimed in claim 9, wherein said time when said first voltage is lowered into said second voltage is controlled in such a manner to be sequentially lowered for each j scan electrodes (wherein j is an integer).
